(19) United States
(12) Patent Application Publication
(10) Pub. No.: US 2006/0172266 A1
(43) Pub. Date: Aug. 3, 2006

(54) Touch sensitive display device

(76) Inventors: Ron W. Rogers, Suwanee, GA (US); David M. Grayson, Atlanta, GA (US); Lynn L. Kerchner, Duluth, GA (US); Lois G. Kemp, Flowery Branch, GA (US); Joseph A. Herro, Lawrenceville, GA (US)

Correspondence Address: PAUL W. MARTIN, NCR CORPORATION, LAW DEPT., 1700 S. PATTERSON BLVD., DAYTON, OH, 45479-0001, US

(21) Appl. No.: 11/035,499

(22) Filed: Jan. 14, 2005

(51) Int. Cl. G09B 21/00

(52) U.S. Cl. 434/112

(57) ABSTRACT

A touch sensitive display device is described. The device has a touch screen and an overlay. The touch screen has a plurality of data entry locations. The overlay has a guide portion and a support portion. The guide portion has one or more apertures and one or more tactile markers, where each of the tactile markers is adjacent to one of the one or more apertures and corresponds to one of the plurality of distinct data entry locations on the touch screen. The support portion if used to retain the guide portion over the touch screen such that each of the one or more guide apertures is in registration with one of the plurality of distinct data entry locations.

### BACKGROUND OF THE INVENTION

The present invention relates to improvements in or relating to a touch sensitive display device. In particular, the invention relates to a transaction authorization device (TAD) for use with a Point of Sale (PoS) system.

One type of TAD is typically referred to as a PIN pad device and has a group of at least twelve three-dimensional keys (numbers 0 to 9, an Enter key, and a Cancel key) that are depressed by a user to enter the user's PIN (Personal Identification Number). A PIN pad device has the advantage that one of the keys typically includes a raised portion to allow a visually impaired user to determine which keys correspond to which numbers. This allows a visually impaired customer to navigate around the PIN pad device and thereby enter a transaction authorization PIN.

Another type of TAD is typically referred to as a signature capture device and has a touch sensitive panel overlying a display. A signature capture device enables a user to authorize a credit card transaction by writing a signature on the panel using a stylus, and to authorize a debit card transaction by touching the panel at locations corresponding to numeric key areas presented on the display (as a virtual PIN pad) and thereby enter the user's PIN.

It is desirable for retailers to use a signature capture device because it is able to authorize both credit transactions (using a signature) and debit transactions (using a virtual PIN pad), thereby saving counter space (since only one TAD is used), reducing initial costs (since a PIN pad device is not needed), and reducing ongoing costs in maintenance and service (since only one TAD is needed).

However, a signature capture device has considerable disadvantages for a user who is visually impaired. One problem with a signature capture device is that a visually impaired user cannot discriminate between key areas on a flat touch sensitive panel when entering a transaction authorization PIN. Another problem is that a visually impaired person requires assistance to be able to enter his PIN, typically involving the user divulging his PIN to the person providing assistance, which compromises the security of the visually impaired user's PIN.

It is among the objects of one or more embodiments of the present invention to allow a visually impaired person to operate a touch screen device.

### SUMMARY OF THE INVENTION

According to a first aspect of the present invention there is provided a touch sensitive display device comprising: a display for presenting a plurality of distinct data entry locations to a user of the device; a touch sensitive panel mounted above and in registration with the display, and a guide plate mounted above and in registration with the touch sensitive panel; the guide plate defining a plurality of apertures, and including a unique tactile marker adjacent each aperture and corresponding to one of the plurality of distinct data entry locations presented on the display, so that a visually impaired user can select a desired data entry location by feeling a tactile marker corresponding to the desired data entry location and touching the panel through an aperture adjacent the felt tactile marker.

Preferably, the guide plate also includes a support portion for retaining the guide portion over the touch sensitive panel in a fixed spatial relation. The support portion may include a rim, or legs, or such like for maintaining a vertical gap between areas of the guide plate defining the apertures and the touch sensitive panel.

Preferably, the touch sensitive display device includes a transparent protective surface above the touch sensitive panel. The protective surface may be a coating applied to the touch sensitive panel, or a sheet that is mounted onto the touch sensitive panel.

The touch sensitive display device may also include a storage area for storing the guide plate when not in use. Conveniently, the storage area is in the form of a storage bay defined by a housing of the touch sensitive display device.

The guide plate may also include a handle portion so that it may be easily mounted onto and removed from the touch sensitive display device. Conveniently, the handle may be in the form of a tab upstanding from a surface of the guide plate.

Preferably, each aperture is dimensioned to reveal only one distinct data entry location to ensure that a user does not accidentally select an undesired data entry location.

Preferably, the unique tactile markers are either above or below a surface of the guide plate, that is, the unique tactile markers are in relief. Alternatively, the unique tactile markers may be areas of high friction relative to the surface of the guide plate.

Preferably, these tactile markers may be any of a number of tactilely discernable indicia, including Braille markings, Moon markings, various American with Disabilities Act (ADA) approved markings, or a marking from any other tactile writing system.

It should now be appreciated that this aspect of the invention has the advantage that a visually impaired customer may complete a transaction with the same degree of autonomy and privacy as a customer having no visual impairment.

According to a second aspect of the present invention there is provided a guard for enabling a visually impaired person to enter data using a touch sensitive panel of a transaction authorization device, the guard comprising: a guide portion defining a plurality of apertures there through, the apertures being arranged to correspond to a layout of distinct data entry areas presented on a display of the transaction authorization device; and a support portion for coupling the guide portion to the touch sensitive panel and for retaining the guide portion in registration with the touch sensitive panel, so that data entry areas presented on the display are revealed by the apertures defined by the guide portion thereby allowing a user to determine which aperture corresponds to a desired data entry area by touching the guide portion.

The support may couple directly to the touch sensitive panel, or indirectly, for example by contact with a housing in which the touch sensitive panel is mounted.

According to a third aspect of the present invention there is provided apparatus for enabling a visually impaired person to enter data on a touch screen where one or more data entry locations are displayed on the touch screen, the apparatus comprises: a guide portion; a support portion for retaining the guide portion over the touch screen; and one or more apertures defined by and extending through the guide portion, wherein when the guide portion is retained over the touch screen each of the one or more apertures is in registration with one and only one of the one or more data entry locations such that the one or more apertures can be used by a visually impaired person to locate the desired one of the one or more data entry locations thereby allowing the visually impaired person to operate the touch screen device using only the sense of touch with out any visual assistance.

Preferably, the guide portion includes one or more tactile markers disposed thereon and located in proximity to the one or more apertures, such that each aperture has a corresponding tactile marker.

By virtue of this aspect of the invention, a visually impaired person can select a desired data entry location and thereby operate the touch screen device using the sense of touch alone.

According to a fourth aspect of the present invention there is provided a transaction authorization device for enabling a visually impaired person to enter data using a touch screen of the device where a plurality of data entry locations are displayed on the touch screen, the device comprises: a template having a top side and a bottom side opposite the top side; a plurality of guide apertures defined by and extending through the template from the top side to the bottom side; and a support for retaining the template over the touch screen and maintaining each of the plurality of guide apertures in registration with a respective one of the plurality of data entry locations.

The template and support are preferably a one piece construction.

Preferably, a plurality of tactile markers are disposed on the top side of the template, wherein each of the plurality of tactile markers is adjacent to one of the plurality of guide apertures and corresponds to one of the plurality of data entry locations displayed on the touch screen.

The support may include a lip extending from the bottom side of the template.

The support may include one or more leg portions extending from the bottom side of the template.

The support may include a tab that can be used to move the transaction authorization device into and out of position.

Preferably, one or more tactile markers are disposed on the top side of the template, wherein each of the one or more tactile markers is adjacent to one of the one or more of guide apertures and correspond to one of the plurality of data entry locations.

According to a fifth aspect of the present invention, there is provided a method of enabling a visually impaired user to operate a touch screen device having a plurality of data entry locations, by positioning a keypad template having a plurality of guide apertures over the touch screen such that each of the guide apertures are in registration with one of the plurality of data entry locations.

According to a sixth aspect of the present invention, there is provided a method of indicating via a keypad template with tactile markers disposed thereon which one of a plurality of guide apertures is in registration with a particular data entry location on a touch screen by receiving a keypad template, presenting a keypad to user, and maintaining the template in registration with the keypad.

By virtue of this aspect of the invention a visually impaired person can operate a touch screen device with the same autonomy as a sighted person.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1A is a simplified pictorial view of a touch sensitive display device according to one embodiment of the present invention.

FIG. 1B is a simplified cross sectional view of an upper portion of the device of FIG. 1A.

FIG. 2A to 2D are plan views of a portion (privacy guard) of the device of FIG. 1A and 1B.

FIG. 3 is a perspective view of the privacy guard of FIG. 2A-D.

FIG. 4 is a perspective view of a portion of the touch sensitive device of FIG. 1A.

FIG. 5 is a perspective view of an alternative embodiment of the privacy guard of FIGS. 1-4.

### DETAILED DESCRIPTION

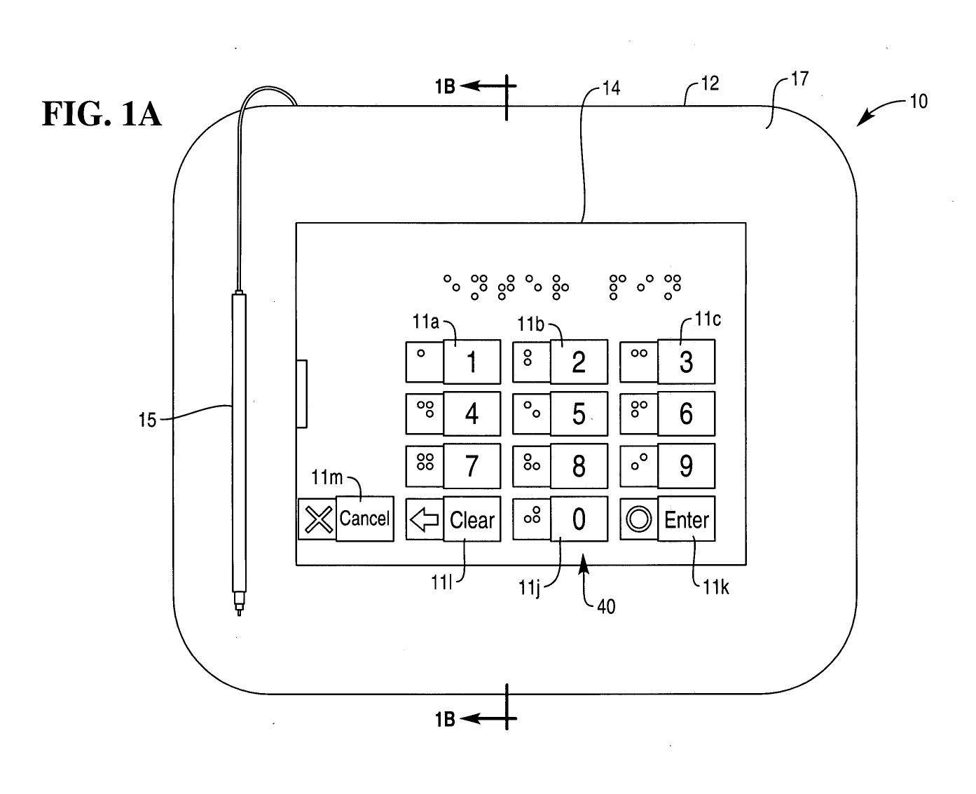

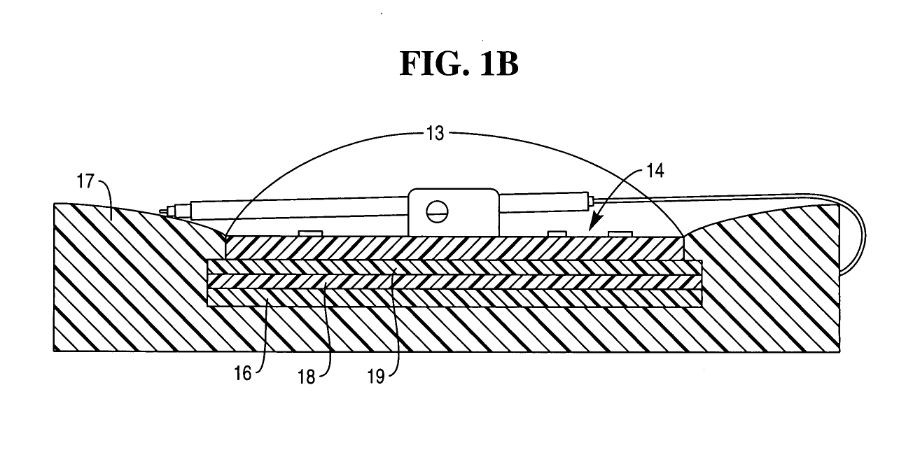

Reference is first made to FIGS. 1-4, and particularly to FIG. 1A, which is a plan view of a TAD 10 according to one embodiment of the present invention. Reference is also made to FIG. 1B, which is a cross sectional view of an upper portion of the TAD 10 of FIG. 1A.

The TAD 10 comprises a base unit 12 on which is mounted a guide plate 14 (referred to herein as a privacy guard). The base unit 12 is a conventional signature capture device, in this embodiment the base unit 12 is an NCR 5993 (trade mark) signature capture device, which is available from NCR Corporation, 1700 S. Patterson Blvd. Dayton Ohio 45479, U.S.A.

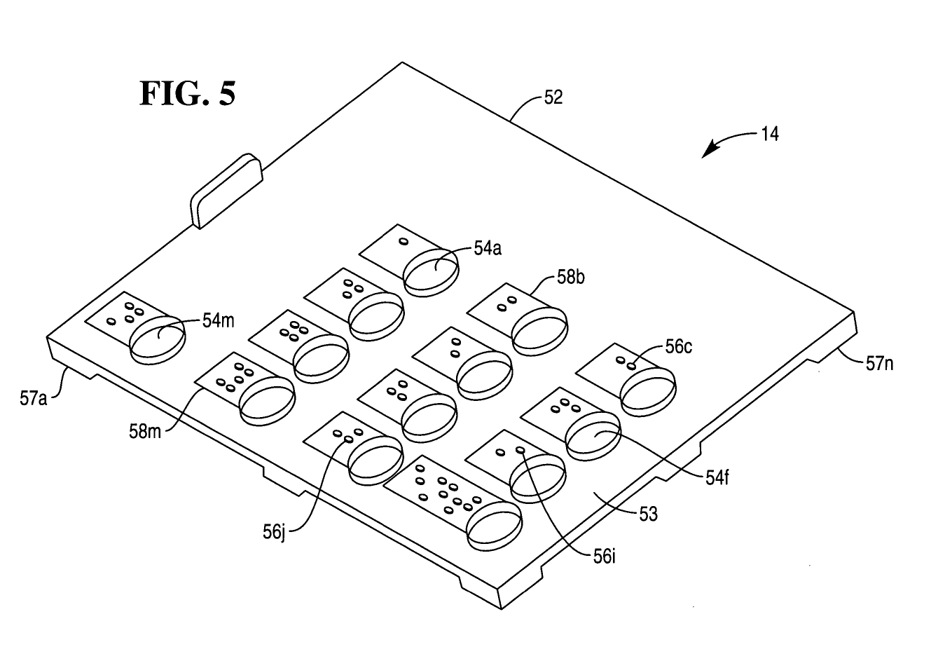

The base unit 12 has a housing 42 (as best shown in FIG. 5) in which is mounted a display 16 for presenting image information to a user of the TAD 10. A transparent digitizer panel 18 is mounted on top of and in registration with the display 16. Similarly, a transparent protective layer 19 is mounted on top of the digitizer panel 18. A bezel 17 is mounted over the transparent protective layer 19, and defines a port 13 through which the display 16 is visible to a user of the base unit 12. A stylus 15 for actuating the digitizer panel 18 is secured to the bezel 17.

The TAD 10 is designed to be used in a retail environment as part of a PoS system and is operable to present information to a user and to receive inputs from a user.

In a debit transaction the display 16 may present an image of a PIN pad 40 (referred to herein as a virtual PIN pad because it is merely an image of a 3-dimensional arrangement) and prompt the user to enter his or her PIN to complete the transaction. As shown in FIG. 1A, the virtual PIN pad 40 is visible through the privacy guard 14. The virtual PIN pad 40 has thirteen distinct data entry locations in the form of keys 11ₐ₋ₘ. Ten of these keys 11ₐ to 11ⱼ correspond to the numerals zero to nine respectively, and three of these keys 11_{k,l,m} correspond to functions. Each of the ten numeral keys 11 a-j is labeled with its associated numeral, for example, key 11_{b} is labeled “2”. Each of the three function keys is labeled with its associated function, namely “Enter” 11ₖ, “Clear”11ₗ, and “Cancel” 11_{m.}

In a credit transaction the display 16 may present a signature capture field (not shown) (in the shape of a rectangle) and prompt the user to enter his signature via stylus 15. A separate guide (not shown) may be provided having an aperture of similar dimensions to the rectangle.

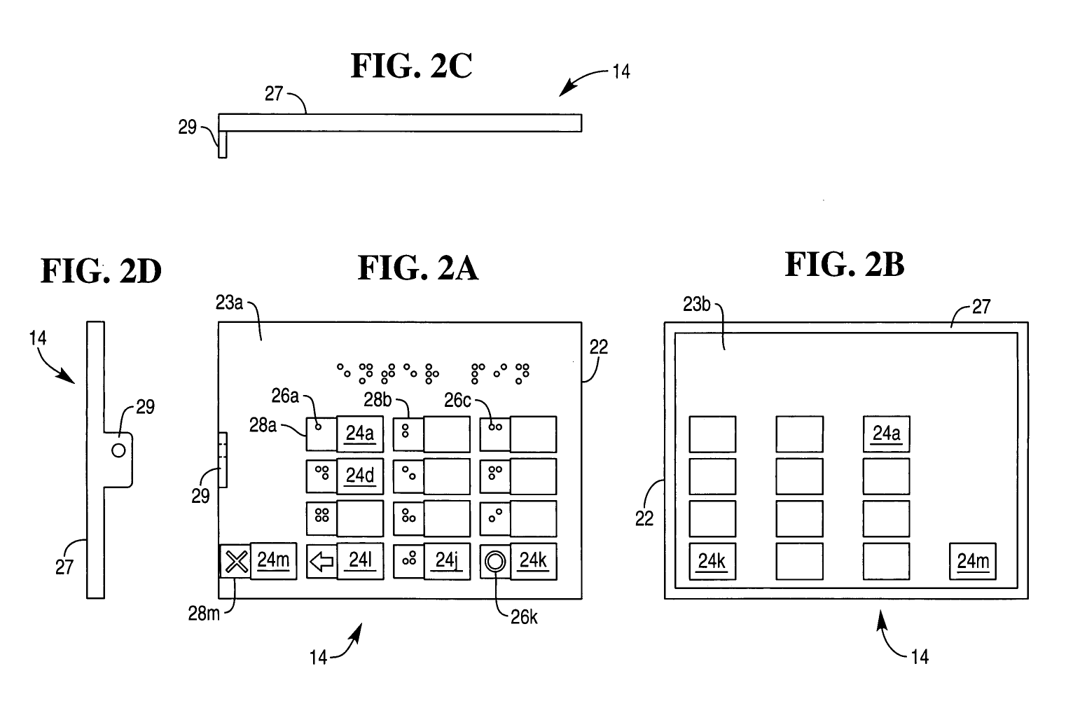

FIG. 2A through 2D show the privacy guard 14 in more detail. The privacy guard 14 includes a guide portion 22 in the form of a platform having a top surface 23ₐ and a bottom surface 23_{b}. Platform 22 defines guide apertures 24ₐ to 24ₘ, each of which extends through the platform 22 from the top surface 23ₐ to the bottom surface 23_{b}. Each of the guide apertures 24ₐ to 24ₘ is dimensioned for receiving a human finger therethrough, although the stylus 15 may be used instead of a finger.

On the top surface 23ₐ of the platform 22 adjacent to each of the guide apertures 24ₐ₋ₘ is one of a plurality of tactile markers 26ₐ₋ₘ. These tactile markers represent and correspond to keys 11ₐ₋ₘ. In the present embodiment the tactile markers 26ₐ₋ₘ represent the number (using a Braille equivalent for each number) and function keys (using a raised ‘x’ for cancel and a raised ‘O’ for enter) that comprise the virtual PIN pad 40.

Each tactile marker 26ₐ₋ₘ is associated with a corresponding one of the guide apertures 24ₐ₋ₘ. Thus the Braille equivalent of the number ‘1’ is associated with key 42ₐ. Raised key indicators 28ₐ₋ₘ are also provided, each one partly surrounding a corresponding tactile marker 26ₐ₋ₘ. Each tactile marker is circumscribed by a raised key indicator and a guide aperture. The raised key indicator 28 can thus be used to tactilely direct a user from a particular tactile marker 26 to the guide aperture 24 associated with it.

As shown in FIG. 2B, the privacy guard also includes support lip 27, which extends from the bottom surface 23b of the platform for mounting the platform over the display 16 when the privacy guard 14 is in use.

The privacy guard 14 also includes a handle portion 29, so the guard 14 may be easily mounted on and removed from the base unit 12. The base unit 12 also includes a storage shelf 52 (as seen in FIG. 5) defined by the housing 42 for storing the privacy guard 14 when not in use.

The privacy guard as show in the embodiment of FIG. 2A through 2D is 122.7 millimeters from side to side, 93 millimeters from top to bottom, 5.1 millimeters thick at the lip 27 and substantially thinner across the rest of the platform 22, and the lip is 3.8 millimeters wide. These dimensions were selected to provide a tight fit to the NCR 5993 signature capture device, for other signature capture devices, different dimensions may be more appropriate.

The privacy guard is manufactured by molding a polycarbonate material. In operation, the base unit 12 displays a virtual PIN pad 40 to allow a user to enter data, such as a PIN. This PIN pad is typically adequate to allow a user to enter data. However, when a visually impaired user desires to enter data, a sales associated can remove the guard 14 from the storage shelf 44 and place the guard 14 in the port 13 defined by the bezel 17.

Referring back to FIG. 1 and FIG. 2, each of the guide apertures 24ₐ₋ₘ are in registration with one of the plurality of keys 11ₐ₋ₘ. Each of the guide apertures 24 is dimensioned so that it is only in registration with one key, thus a user can only actuate one key 11 through any one guide aperture 24.

Each of the tactile markers 26ₐ₋ₘ corresponds to a particular one of the plurality of keys 11ₐ₋ₘ. When a visually impaired user desires to enter a PIN or other information on the virtual PIN pad the user moves a finger over the surface 23a to locate the tactile marker 26 corresponding to a desired key, e.g. 11_{c}. The user then inserts his or her finger through the guide aperture, e.g. 24_{c}, associated with that tactile marker 26_{c} and touches the key 11_{c} which is in registration with that respective guide aperture 24_{c}. The raised key indicator 28_{c} aids this process by tactilely indicating the tactile marker 26c corresponds to a particular guide aperture 24c.

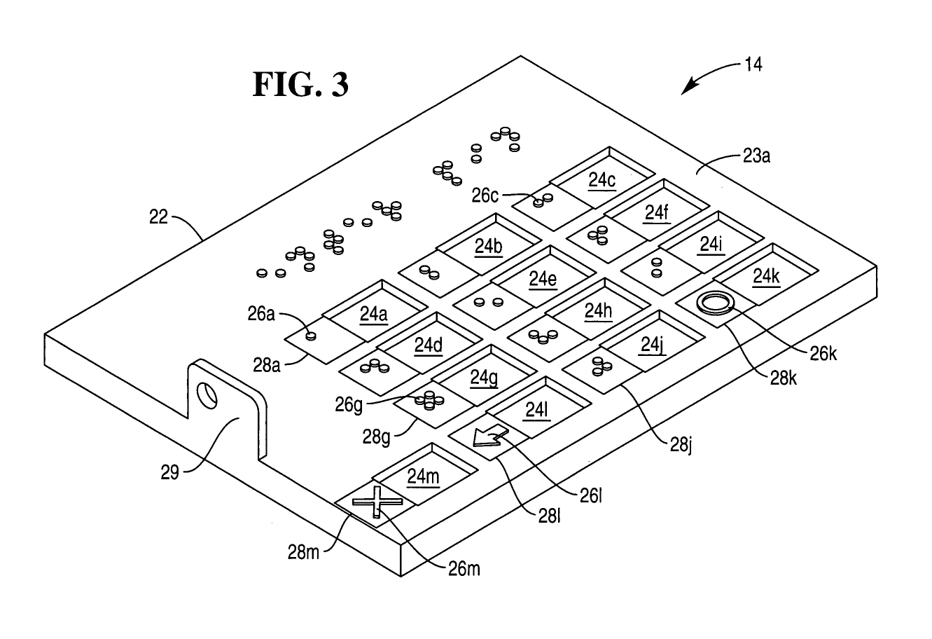

Reference is now made to FIG. 3, which is a perspective view of an embodiment of the privacy guard 14. The privacy guard 14 includes a guide portion in the form of a platform 32 having a top surface 33. Platform 32 defines square guide apertures 34ₐ to 34ₘ, each of which extends through the platform 32.

On the surface 33 of the platform 32 adjacent to each of the guide apertures 34ₐ₋ₘ is one of a plurality of tactile markers 36ₐ₋ₘ. Each tactile marker is associated with a particular one of the guide apertures 34ₐ₋ₘ. Raised key indicators 38ₐ₋ₘ are disposed on the surface 33, one of which partly surrounds each of the tactile markers 36ₐ₋ₘ. Each tactile marker is circumscribed by a raised key indicator and a guide aperture. The privacy guard 14 also includes a handle portion 39.

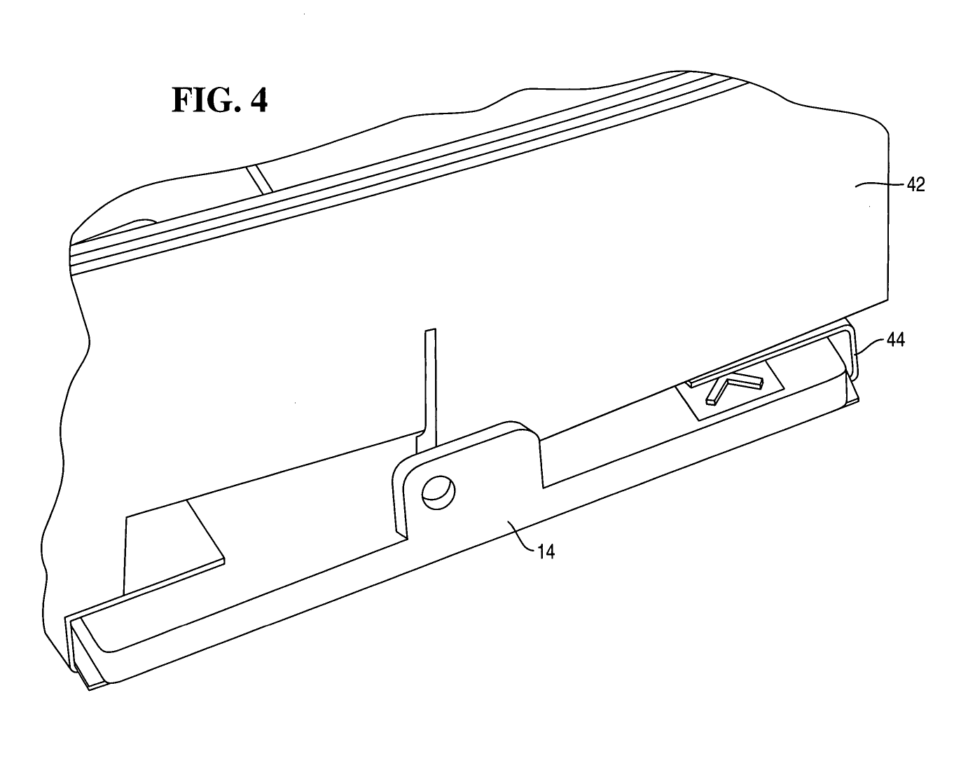

Reference is now made to FIG. 4, which is a perspective view of a portion of the touch sensitive display device. In this embodiment the base unit 12 is shown, including housing 42 and shelf 44 which defines a storage area for privacy guard 14.

Reference is now made to FIG. 5, which is a perspective view of an embodiment of the privacy guard 14. The privacy guard 14 includes guide portion in the form of a platform 52 having a top surface 53. Platform 52 defines round guide apertures 54ₐ to 54ₘ, each of which extends through the platform 52.

On the surface 53 of the platform 52 adjacent to each of the guide apertures 54_{A-M} is one of a plurality of tactile markers 56ₐ₋ₘ. Also, disposed on surface 53 are raised key indicators 58ₐ₋ₘ, one of which partly surrounds each of the tactile markers 56ₐₘ. Each tactile marker is circumscribed by a raised key indicator and a guide aperture.

The privacy guard also includes leg portions 57ₐ₋ₙ, which extends from the bottom of the platform 52 for mounting the platform over the display and creating a spaced relation between the platform and the protective layer.

Various modifications may be made to the above described embodiments, within the scope of the present invention.

It will be appreciated that in other embodiments the platform may be mounted over the display by other means.

It will further be appreciated that the privacy guards can be manufactured by various other processes and from various other materials.

For example, some embodiments do not use a lip to support the platform over the display, and may accomplish this by a variety of other means. For instance, similar to the lip, the platform may be provided with legs extending from the bottom side of the platform for supporting the privacy guard over the display. In use the legs would rest on the protective layer. In other embodiments, the platform may be connected to a movable arm and when need be the arm can be moved in to position, thereby supporting the platform over the display. This arm could be mounted to any of a variety of objects, such as the base unit 12, a counter top, or various other parts of the POS system.

For example, the privacy guard may be pivotally mounted to the base unit, so when it needed it can be quickly pivoted into place. Such an embodiment also has the advantage of keeping the privacy guard from being misplaced.

For example, while the embodiments above refer to the platform being in a spaced relation to the protective layer, the present invention includes embodiments where the privacy guard platform or privacy guard rests flat on the protective layer. In such an embodiment only the areas of the touch screen in registration with the guide apertures will be operable as data entry points.

Furthermore, while the present invention has been described in terms of enabling a visually impaired person to input data into a touch screen device in a retail environment, the invention is applicable to inputting data into touch screen devices found in any environment.

Moreover, while this invention has been described in terms of assisting people who are visually impaired, the invention is not so limited. For example, a person with Parkinson's disease or just simply advanced in years may have great difficulty with precision motor skill such as actuating a small key or button. This is especially true when the button is virtual and it will often be the case that a person with declined motor skills will hit the wrong button or too many of them when operating a virtual key pad. The guide apertures of the present invention are advantageous in that they increase the accuracy by which people of declining motor skills can operate a touch screen device.

What is claimed is:

1. A touch sensitive display device comprising:
a touch screen having a plurality of data entry locations;
an overlay including:
(a) a guide portion having one or more apertures and one or more tactile markers, where each of the tactile markers is adjacent to one of the one or more apertures and corresponds to one of the plurality of distinct data entry locations on the touch screen; and
(b) a support portion for retaining the guide portion over the touch screen such that the each of the one or more guide apertures is in registration with one of the plurality of distinct data entry locations;
wherein a visually impaired user can operate the touch screen device with the same autonomy as a non-visually impaired.

2. A transaction data entry device for enabling a visually impaired person to enter data using a touch screen of a touch screen device where a plurality of data entry locations are displayed on the touch screen, the apparatus comprising:
(a) a template having a top side and a bottom side opposite the top side;
(b) a plurality of guide apertures defined by and extending through the template from the top side to the bottom side; and
(c) a support for retaining the template over the touch screen and maintaining each of the plurality of guide apertures in registration with a respective one of the plurality of data entry locations.

3. Apparatus according to claim 2, and further comprising a plurality of tactile markers disposed on the top side of the template, wherein each of the plurality of tactile markers is adjacent to one of the plurality of guide apertures and corresponds to one of the plurality of data entry locations displayed on the touch screen.

4. The apparatus according to claim 2 wherein the support comprises one or more leg portions extending from the bottom side of the template for engaging the touch screen device and holding the template over the touch screen.

5. The apparatus according to claim 2 wherein the plurality of data entry locations comprise an image of a PIN pad.

6. The touch screen device according to claim 5, further comprising a storage area for storing the overlay when not in use.
